(19) United States
(12) Patent Application Publication
(10) Pub. No.: US 2005/0165849 A1
(43) Pub. Date: Jul. 28, 2005

(54) Extended intelligent video streaming system

(75) Inventors: Ahmad Moradi, Ft. Lauderdale, FL (US); Arash Jalali, Ft. Lauderdale, FL (US)

Correspondence Address: FLEIT KAIN GIBBONS GUTMAN BONGINI & BIANCO, COURVOISIER CENTRE II, SUITE 404, 601 BRICKELL KEY DRIVE, MIAMI, FL, 33131, US

(73) Assignee: G-4, Inc., FT. LAUDERDALE, FL (US)

(21) Appl. No.: 11/087,363

(22) Filed: Mar. 23, 2005

Related U.S. Application Data
(63) Continuation-in-part of application No. 10/634,733, filed on Aug. 5, 2003.
(63) Continuation-in-part of application No. 11/011,537, filed on Dec. 14, 2004.

(51) Int. Cl. G06F 7/00

(52) U.S. Cl. 707/104.1

(57) ABSTRACT

A system for transmitting and displaying large media files uses an online streaming service to upload full-length movies and other video and audio files to a wide array of viewers. The system includes a robust, scalable, and fast upload technique that allows files of any size to be uploaded to customers' accounts by the customers. It is specifically tuned to handle hundreds of uploads per second of files which are typically several hundred mega bytes large. Increased scalability is achieved by clustering servers behind a front-end server than gives customers a relative level of distribution transparency.

### RELATED APPLICATIONS

This application is a continuation-in-part of U.S. patent application Ser. Nos. 10/634,733 filed Aug. 5, 2003 and 11/011,537 filed Dec. 14, 2004.

### TECHNICAL FIELD

The present invention generally relates to methods and devices for transmitting and displaying audio and video files, and deals more particularly with a system for on-line streaming of large audio and video files such as movies, commercials and the like, as well as to techniques for uploading such files and optimizing their display.

### BACKGROUND OF THE INVENTION

Computer based networks, including those employing the Internet are being used with increasing frequency to transmit relatively large audio and video files from content providers to a variety of users for entertainment and other commercial purposes. New services such as paid video-on-demand and video conferencing combined with the continued roll-out of new forms of netsurfing, media appliances, such as PDAs, cellular phones and Web-TV promise to open important new markets to content providers. Many of these services use system architectures for uploading audio and video files require that the user to have converters, decoders or other specialized hardware or decompression software to play the files. Additionally, even where the user possesses the necessary hardware/software, the files are not always displayed in an optimized manner because of differences in the appliances employed by the users. This is due in part to the variety of media player formats used by different media appliances, as well as to the various speeds at which the media appliances may be connected to the internet. A challenge therefore exists in choosing the type of media file which is to be displayed in order to provide the user with the best viewing experience. This problem is exacerbated by the fact that differing types of media files of the same video production have differing pixel resolutions. As a result, the width and height of the video that would ordinarily be displayed for a chosen file type may not be optimized for the particular configuration of the viewer's computer, and the bandwidth of the viewer's connection.

### SUMMARY OF THE INVENTION

According to one aspect of the invention, a method is provided for sending and playing video files using IP or the Internet Protocol along with any number of transport protocols including but not limited to TCP (Transport Control Protocol), UDP (User Datagram Protocol), and RTTP (Real-Time Transfer Protocol), comprising the steps of storing the files at a file server site; sending a video file request from a user site to an intelligent streaming server at the file server site; receiving the video file request at the file server site; determining the optimum settings of video for the requested video file using an intelligent scoring algorithm; in response to the video file request, streaming the contents of the requested video file to the user using application protocols including but limited to HTTP, RTSP, MMS over the above mentioned network and transport protocols; and, playing the requested video file being streamed at the user site using the optimum settings.

According to another aspect of the invention, a method is provided for sending and playing media files, comprising the steps of hosting a plurality of media files at a server site; receiving requests for media-on-demand from users, wherein each request represents a demand by a user that a user-selected media file be uploaded from the server site for playing at the user's site; uploading the requested media files to the users' sites using application protocols tunneled through FTP and over TCP/IP networks; optimizing the display of the uploaded files at the users' sites using an intelligent scoring algorithm; and, playing the requested media files at the users' sites in their optimized forms.

In accordance with still another aspect of the invention, a method is provided for uploading a video file from a client computer to a user site through TCP/IP or the Internet connection. The method comprises the steps of: sending a file upload request from the user to the server; sending information from the user to the server identifying the name and path o the video file to be uploaded, the speed of the user's connection and the type of player that the user will use to play the uploaded video file; selecting a video file that best matches the information provided by the user; and, uploading the selected file.

It is therefore a primary object of the present invention to provide improved media-on-demand using TCP/IP and intelligent streaming techniques supporting multi-video formats.

Another object of the invention is to provide a system as described above that optimizes playback of media files for the user, based on the user's installed media players and bandwidth connection.

A further object of the invention is to provide a system of the type mentioned above that reduces the time required for uploading media files to a user.

These, and further objects and advantages of the invention will become clear or made apparent during the course of a description of a preferred embodiment of the inventions.

### BRIEF DESCRIPTION OF THE DRAWINGS

FIG. 1 is an overall diagrammatic view of an extended intelligent streaming system including its users, which forms a preferred embodiment of the present invention.

FIG. 2 is a block diagram showing details of the architecture of the extended intelligent streaming system shown in FIG. 1.

FIG. 3 is a diagram showing the sequence of events in a typical interaction between the client and server during an upload session.

FIG. 4 is a flow diagram showing the steps in the procedure the preferred client-side embodiment of the uploader part of this invention must follow before sending any commands to the server.

FIG. 5 is a flow chart showing the broad steps for displaying sending and displaying a video file using the intelligent streaming system.

FIG. 6 is flow chart showing the steps for automatic selection of a video file.

FIG. 7 is a flow chart showing the steps for scoring player conformity.

FIG. 8 is an overall diagrammatic view of the intelligent streaming system arranged to act as a gateway for channeling video streaming from RTSP servers to on-line recipient users.

### DETAILED DESCRIPTION OF A PREFERRED EMBODIMENT OF THE INVENTION

The present invention is, in part, an improvement over a system for generating and displaying video and audio files described in U.S. patent application Ser. No. b 10/634,733 filed Aug. 5, 2003, and 11/11,537 filed Dec. 14, 2004, the entire disclosures of which are hereby incorporated by reference herein.

U.S. patent application Ser. No. 10/634,733 mentioned above discloses an Intelligent Video Streaming Server and related logic (hereinafter “IVSS”), in which video commercials are hosted at IVSS and client-user can place those embedment into its own web site for transparent online universal viewing supporting multi-video formats and email which is generated by combining video and sound in one small envelope that can be emailed for a variety of applications, such as marketing, advertising and other service applications. The video e-mail is generated in an appropriate file size, bandwidth and compatibility. The generated e-mailed video requires no special player to view it, and has a very small file size e.g. under 800K for thirty-seconds of video when sent as an attachment. The file size of the video e-mail when sent as a streaming work with ad-server is no more than 15-20K (Kilo Bytes). By the advent of this prior invention, instead of a text message, the business world can empower their web site with intelligent display of video, and send video messages that offer the dynamics of color, movement, sound and have emotional appeals.

U.S. patent application Ser. No. 11/11,537 filed Dec. 14, 2004 discloses a method for selecting video files such as those accompanying the video emails mentioned above, that best suits the user's network and player configuration. The ultimate recipient of the video email is able to watch the right video format without any decision on their part. An algorithm finds the optimum choice among the qualified players, media settings, desktop settings, and bandwidth connection. The inventive method includes the steps of identifying the right media files for user viewing, and scoring each possible media file. The file that has the highest scores wins and is selected. The scoring and decision criteria with 2 initial components define conformity score, and connection speed score.

The present invention supports a broader business model compared to the previous IVSS ad server, and possesses various enhancements and technical advancements. As used herein, the inventive, extended IVSS of the present invention will be referred to as “e-IVSS”, and the system described in U.S. Ser. No. 10/634,733 will simply be named “IVSS”. Whereas the IVSS ad-server was aimed at generating revenue from subscriptions of businesses and advertisers wanting to advertise their products and services using short (typically 30 second long ad's), the present e-IVSS provides an online streaming service of full-length movies and other video and audio files to a wide array of viewers as well as content providers, through services such as pay-per-view, web casts, etc. The e-IVSS includes a robust, scalable, and fast upload service that allows files of any size to be uploaded to customers' accounts by the customers. It is specifically tuned to handle hundreds of uploads per second of files which are typically several hundred mega bytes large.

The present invention supports increased scalability by clustering servers behind a front-end server than gives customers a certain level of distribution transparency. Customers may log on to the font-end and the front-end decides which server their media content is stored on. This is true for viewers and those who watch movies off IVSS servers, who need not concern themselves with which server holds the movie they are trying to watch. The front-end dispatches users request to the correct server automatically.

As will be discussed below, the e-IVSS keeps track of paid viewers' credit and account, and produces appropriate accounting reports to the customers and the IVSS administrator. Furthermore, the present IVSS is capable of interfacing with third-party online payment handling systems.

In contrast to the IVSS which relied solely on HTTP as its application protocol, and Microsoft IIS as the web server to deliver the media content to viewers, the present e-IVSS interfaces with other types of protocols and content servers such as RTSP (Real-Time Streaming Protocol) and third-party content servers such as Microsoft Media Service, RealNetworks' Helix server, MPEG Server, Macromedia Flash Server, and Apple's QuickTime media server.

As previously implied, the prior IVSS served as a back-end for on-line video advertising campaigns. Advertisements could be produced containing small and easy-to-download video/audio clips that could automatically and intelligently adjust themselves to the viewer's software configuration as well as her network connection characteristics. The IVSS could serve two different marketing models, namely a pull model and a push models. In the pull model, the viewer receives a properly and automatically chosen video/audio clip whenever she visits a web-site. One or more web-pages on the web site contain, along with other relevant content, live video advertisements that the viewer might chose to see by clicking on a hyperlink, or automatically whenever she visits those pages. It is called the pull model because the video is delivered to the viewer upon her direct or indirect request.

In the push model however, the advertisement video/audio is delivered (pushed) to the viewer's screen usually through email-based technology.

Irrespective of whether the IVSS served a push or pull model, the main assumption was that it functioned as an ad-server, i.e. a back-end server to stream relatively short advertisement video/audio clips, and that the user views the video or hears the audio as a side effect of an originally intended action, i.e. visiting a website or checking one's email. In other words, the viewer's role here is passive. The collateral nature of the IVSS's operation and the passive role of the viewer led to the following constraints: (1) The video/audio clips should not be too long, and their length should not surpass a typical passive viewer's attention span, and (2) the play-back of the video/audio clip should require minimal amount of effort on the part of the passive viewer.

Unlike the IVSS, the e-IVSS of the present invention may serve both passive as well as active viewers. Active viewers are those individuals who receive video/audio content from an e-IVSS server with the explicit intent of watching a motion picture or audio production. As will be described below, this feature opens a new market for the e-IVSS with a whole new array of possible business models. As will be described in more detail later herein, the potential modes of interaction of the present e-IVSS with active viewers may be summarized here as follows:

(1) Pre-paid video on-demand: Viewers can become subscribers to an IVSS driven service. The subscription fee may be flat, i.e. monthly, weekly, annual, etc., or credit based (pre-paid) in which case the viewer subscribes to the service and then he/she would purchase credit points that he/she can use to watch any movies made available on that service. For sake of simplicity, hereafter, video and motion picture production shall mean video and/or audio, unless otherwise stated.

(2) Pay-per-view video on-demand: The viewer selects a movie or any other motion picture production, watches a short preview to test the quality of transmission and then pays to see the full-length movie. The e-IVSS handles the payment by interfacing with a payment gateway in the back-end.

(3) No-charge video on-demand: Video on demand may be used in a no-charging setting for companies that use video as a means of communication with, and/or education for their staff.

(4) Promotional: This form of interaction is similar to that described with reference to the previous IVSS.

The e-IVSS of the present invention is useful not only for PCs and laptop users, but to hand-held devices users as well, such as PDA's, Pocket PC, Web-TV, cellular phones and other mobile viewing devices installed on transportation vehicles, e.g. automobiles, airplanes, and trains.

As used in the present disclosure, the following terms will have the meanings set out below:

Auto-player: e-IVSS's web-based application that uses the display optimization technology of the present invention to automatically determine the best possible movie format to be played back to the viewer without any human intervention.

Client: An individual or company that acquires a license to use the e-IVSS, either as a customer or an e-IVSS server administrator.

Customer: An individual who has acquired a usemame/password credential from an e-IVSS administrator to logon to the IVSS customer control panel to upload files and manage video, audio or image folders. A customer might or might not be an e-IVSS license holder.

License: Permission granted to an individual or corporate entity to use the services of an e-IVSS system by the licensor. The permission might cover the usage of a single customer account, or to manage and control a complete e-IVSS streaming solution.

Video Player: Any of the various commonly used programs for viewing motion picture productions and listening to music and other audio productions, such as the Microsoft Windows Media Player, RealNetworks RealPlayer (now called RealONE), Apple QuickTime, and Macromedia Flash Player.

Viewer: An individual invited (via an advertisement) or explicitly demanding to watch a motion picture, or listen to an audio content hosted on an e-IVSS streaming server.

Having generally discussed the possible modes of interaction between the user and the e-IVSS, the following describes in more detail how these various modes of interaction can be used in differing business models for commercializing the e-IVSS of the present invention.

Video-On-Demand

Video on-demand means a user can choose to view a video at his/her time of choosing. This is could be for entertainment, education, or information. Typical scenarios are:

1. An individual wants to watch a movie over the Internet at home or at his/her office.

2. A person waiting for his/her flight at the airport, watches a movie on his/her hand-held Internet-enabled device.

3. Parents wanting their children to watch a movie in their car during a long journey.

4. An employee of a corporation watching a training film on the newly installed office automation system.

5. A student in an online education program watching the pre-recorded film of his/her teacher's weekly lecture.

On-demand video in combination with e-IVSS can make several business models viable. In the subsections that follow, some of these business models are discussed.

Pay-per-view with co-host or dedicated hosting. A client can acquire a license for a co-hosted e-IVSS account or a dedicated hosted server to offer pay-per-view streaming services to movie fans. Visitors can browse through a movie album and after watching a preview could embark on paying to watch the fill movie. E-IVSS, by interfacing with payment gateways through its own accounting engine, can handle the payment. It can then use the later described image optimizing technology of the present invention to broadcast and stream that version of the movie that perfectly matches the user's computer and network configuration.

Credit-based with co-host and dedicated hosting. The same scenario as above can be envisaged with a credit-based scheme. Frequent viewers can acquire credits through online coupons, or purchase pre-paid cards for specific movie titles or genres. In the case of online coupons or pre-paid cards, both bear a randomly generated multiple-digit serial number. Upon selecting a movie for viewing, and selecting the pre-paid option for payment, the viewer is asked by the e-IV˜8 accounting backend to enter his/her serial number. If the serial number is correct, and there was enough credit for the selected movie on that pre-paid account, the movies will be chosen using the Intelli-1 (intelligent algorithm sensor) technology will be streamed to the viewer.

Permission-based (no-charge viewing). This scheme, which is particularly suitable for useful for in-house servers used in corporations, allows an administrator to create a video folder and upload movie files in different codec formats to that folder and specify who is allowed to view that movie. Users can be identified through a username/password mechanism. Upon logging on to a special portal, the user can see the list of movies he/she is allowed to watch. This can be implemented using the idea of coupons. Each coupon is bound to a specific movie title and the permission to pick and use the coupon is assigned to authorized users.

Advertising Model

This is the usage model utilized in connection with the previous IVSS. The major characteristic of this model as opposed to video on-demand is that the viewer does not initiate viewing as a primary intent with short video clips of up to 10 minutes.

The target domain of the e-IVSS will now be discussed. As used herein, target domain refers to the variety of platforms, both software and hardware, to which e-IVSS can provide streaming services. Whereas the previous IVSS was suitable for home and office PCs as well as Laptop computers, the present e-IVSS has application to a wider range of hardware and software operating system (OS) platforms, including but not limited to:

1. Windows-based PCs and Laptops, including all versions of Microsoft Windows up to and including all versions of Windows 2003.

2. All major Personal Digital Assistants (PDA's) running operating systems such as Windows CE (officially called Pocket PC from version 3.0 onwards), and Palm OS. Many of the currently available handheld devices especially PDA's come equipped with their own media player and browser software. eIVSS recognizes requests made from such devices and adapts its streamed content based on their playback capabilities.

3. Other internet-enabled operating systems run over handheld devices such as new models of mobile phones running on Java, Symbian, etc.

4. Embedded internet-enabled display devices, such as IP/TV, Web TV, embedded TV's inside cars, trains, etc.

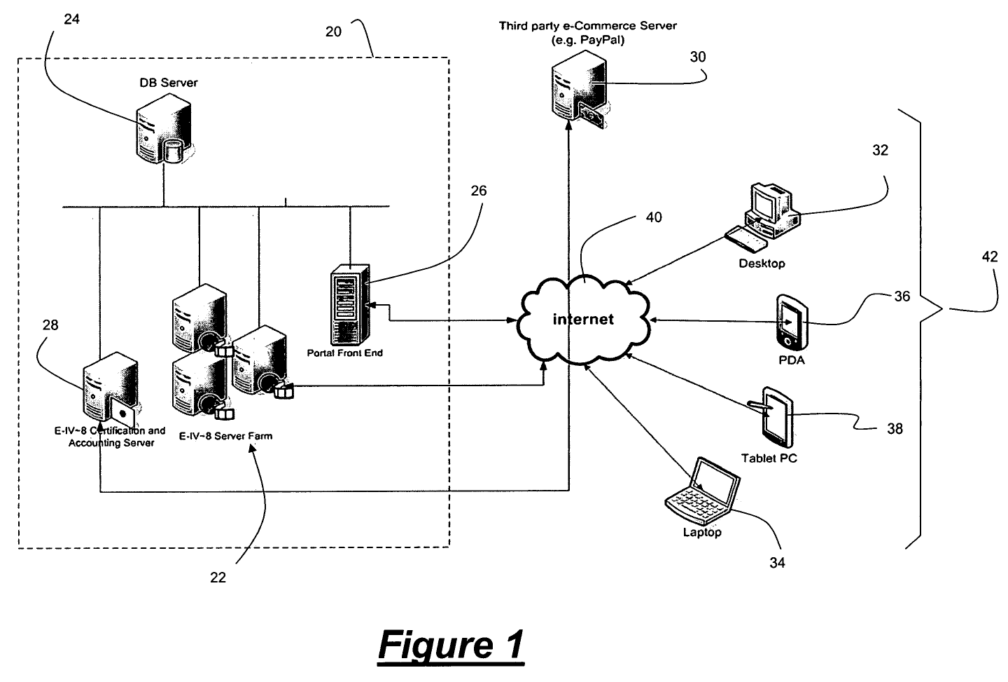

Having described the business models and application of the present e-IVSS compared to the prior IVSS, the details of the inventive e-IVSS and related technology will now be discussed in detail. In order to better understand the architecture of the e-IVSS, it is helpful to appreciate the operating environment in which it interacts with other entities such users, external systems, etc. In this connection, reference is now made to FIG. 1, which depicts the e-IVSS operating environment in simplified, diagrammatic form. The environment of the e-IVSS broadly comprises a collection of servers 20, a third party payment handling or e-commerce server 30 and a plurality of client internet enabled devices 42 which communicate with the servers 20 via the internet 40. The servers 20 include a farm of e-IVSS streaming servers 22, a dedicated DB server 24, an accounting and certification server 28 and a front-end portal server 26. The client internet-enabled devices 42 may, for example, include PCs 32, laptops computers 34, PDAs 36 and a tablet PC 38, as well as other similar devices.

It should be pointed out here that FIG. 1 depicts a maximal, configuration for the e-IVSS operating environment, and that in its most simplistic form, there may be only a single streaming server 22, one DB server 24, and a group of clients 42. Furthermore, each of the servers in the collection 20 functions in a singular role. In actual practice, one physical server computer might fill one or more of these roles. For instance, it is possible that a single server computer could perform the functions of streaming server, a front-end portal, as well as the DB server. It also possible that for performance reasons, any of the functional roles mentioned above might be filled by more than one server, as is the case in the configuration shown in FIG. 1 where multiple servers 22 are used to fulfill the streaming function.

Turning now to a description of the operation of the system shown in FIG. 1, a client might belong to an e-IVSS account owner who wants to log to e-IVSS's customer control panel using PC 32 to upload and manage his/her video/audio/image files and folders. If, for any reason such as performance, more than one e-IVSS streaming server 22 is setup by the service providers, then a front-end portal 26 will help the clients connect to the server 22 on which their account is setup without having to remember their server's individual name and address. The front-end portal 26 is therefore where all clients will connect to for log on. After they have provided their username/password credentials, the front-end portal 26 authenticates them and redirects them to the server 22 on which their videos are hosted. In the event that a service provider only operates one e-IVSS streaming server 22, a front-end portal 26 will not be necessary.

A client may also be operated by a viewer—an individual interested in watching a video, or listening to an audio file. In this case, direct contact might be made to the server 22 that hosts the desired video files. However for clips that require payment or authorization, the front-end 26 will again take control and the client should first contact the front-end portal 26, providing it with the required credentials. The credentials may comprise a payment confirmation number in a pay-per-view scenario, or it might be a coupon or PIN (personal identification number) in the case of a pre-paid viewing scenario, or alternatively, it might be a username/password for a viewer in a no-charge, permission-based model. Except for the latter scenario, the front-end-portal 26 confers with the accounting and certification server 28 to check the credit balance before authorizing a stream to be sent to the client.

The certification and accounting server 28 is responsible for credit record keeping. Its role is to act as a middle-man between the e-IVVS servers 22 and the external payment handling server 30, which may be a system such as PayPal. When potential viewers make their payments through these payment handling systems, they securely communicate the confirmation of this payment with e-IVSS's certification and accounting server 28. Whenever the front-end portal 26 asks the accounting server 28 to check a client's credit, the accounting server 28 will query its own database (server 24) to report on the client's credit, as well as to update it to reflect the fact that the credit has been used.

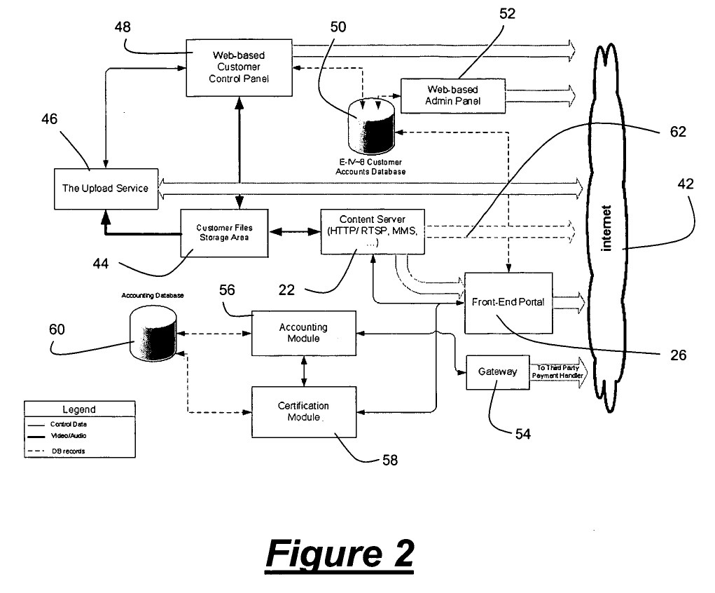

FIG. 2 shows the architecture of an embodiment of e-IVVS of the present invention and is useful in understanding the relationship and operation of the various components comprising the system. A web based customer control panel 48 is a web-based application that is used by those e-IVSS's users who have a username/password account to upload and manage their video and audio folders and files. The panel 48 can be accessed directly, or indirectly through the front-end portal 26 by users over the internet 42 The control panel 48 functions to create, delete, and configure video, audio and image folders, as well as to upload video, audio, and image files.

A web-based administration panel 52 is also a web-based application that is used by the e-IVVS service provider. The administration panel 52 functions to create, disable, enable and remove accounts. The panel 52 also functions to configure e-IVVS accounts in terms of the maximum disk quota, maximum allowed bandwidth, list of file types permitted to be uploaded to that account, DNS name of the customer's e-IVVS site, using which the videos and audios are made available to the public.

Since the web-based control panel 48 uses HTTP POST for uploading files to an account, it may not be suitable for uploading large files (100 MB and larger) both in terms of upload speed experienced by the end-user as well as memory and CPU usage on the server side. Therefore an FTP based upload service module 46 along with an upload client embedded into the web-based control pane 48, provide a robust means for uploading files of any size. As shown in FIG. 2, the upload service has the ability to be directly used over the internet 42, as well as to be used within the context of a customer control panel session. The service listens to a configurable TCP port (by default port XXXX where “XXXX” represents a port number, and tunnels its communication with its client through the FTP application protocol. This means that it is possible to communicate and use the services of the upload service using a typical FTP client, although a specially tailored client will make the user experience much easier. Also, certain FTP commands, such as those for creating directories, downloading files, etc. which are well known in the art have not been shown for sake of simplicity since they are incidental to the function of the upload service. Further details of the upload service will be discussed shortly.

The content server 22 shown in FIG. 2 may, for examples comprise the Microsoft Internet Information Services which serves content over the HTTP application protocol. However, e-IVVS may be equipped to handle servers working with other application protocols such as the RTSP (Real Time Streaming Protocol). The dashed arrow 62 is intended to indicate that the content server module may provide direct access by internet users, in which case there is no need for intervention by the front-end portal 26. This is usually the case for short preview clips of movies, or advertisement movies where no authentication or payment for viewing is required. For protected content, only the requests channeled through the front-end portal 26 will be responded to, therefore protected content is not directly accessible through the content server(s) 22.

For paid content, especially for pay-per-view schemes, viewer customers pay through online payment handling systems such as PayPal. When a viewer makes the payment, these payment systems usually have this capability to make a B2B communication with another online system to inform it of the successful conclusion of the transaction. The accounting module 56 in the accounting and certification server 28 captures these B2B notifications and records it into its own database. As soon as the payment is registered in the database, the e-IVVS will be cleared to serve that customer, if and when that customer provides appropriate evidence, such as PayPal payment confirmation number, coupon number, etc. Since the accounting module 56 should potentially interface with a wide array of external payment handling systems, a separate module designated as a gateway 54 in FIG. 2 serves as a communications driver that encapsulates the B2B communication protocol between the accounting system and the external system. This architecture ensures scalability of the accounting server 28, in the event that new payment handling systems become popular over the Internet.

The certification module 58 acts as a gateway between the front-end portal 26 and the accounting system 56, 58, 60. Module 58 provides a unified interface for the front-end to check viewers' credits before allowing for their streaming requests to be served. It should be noted here that the accounting and certification server 28 should be located on a different server on a remote geographical location from where the e-IVVS front-end portal is running. The communication protocol between the portal and the accounting and certification servers is therefore provisioned to use XML-formatted messages sent through a secure HTTP channel over the internet

The front-end portal 26 provides an e-IVVS customer (a user with a valid customer control panel username/password) with a unified logon portal and upon successful authentication redirects that user to the server that hosts his/her video, audio and image files (this feature is only applicable when there is an e-IVVS server farm 22). The front-end portal 26 also acts as the only entry point for paid viewings. Furthermore, portal 26 receives credentials from viewers (payment confirmation number, coupon number, pre-paid card PIN number, etc), and communicates with the accounting and certification server 28 for credit verification, and upon successful validation, instructs the content server to open a stream to that particular viewer. Finally, the front end portal 26 functions to authenticate permission-based on-demand viewers. As previously described, permission-based viewing requires viewers also to identify themselves so that e-IVVS can provide video content to them based on their assigned permissions. These permission checks are also performed by the front-end portal, especially when there is an e-IVVS server farm 22.

An important part of the interaction between the e-IVSS and its user (customer) consists of file uploads by the customer to his/her account. This upload may be performed through the web-based customer control panel 48 using the HTTP protocol. Alternatively, a non-HTTP upload agent may be employed, which in some cases may provide improved performance in terms of upload time experienced by the customer, as well as CPU and memory usage on the server. These performance improvements are significant where large files, such as full length movies are being uploaded.

The details of the preferred upload agent used with the e-IVSS will now be described. The upload agent, which will be referred to hereafter simply as the “uploader”, is based on the client-server model. The uploader is specifically designed to satisfy meet several important criteria and achieve certain goals. First, it is important to minimize the time required for a movie file to be uploaded to the e-IVSS. Second, a robust means must be provided to accommodate a large number (several hundred) of potentially huge (100-600 megabytes large) file uploads per hour without any significant drop in the server's available resources, especially free memory. Finally, the customer should be provided with same platform-neutral ease-of-use experience as the web-based user interface and while maintaining as much coherence between the web-based interface and the uploader client as possible.

The server-side software of the uploader is designed and implemented with two important technical and strategic objectives, namely, short development time and high reliability. For this reason, the protocol governing the communication between the server and the client should is based on the FTP application protocol. FTP is quite reliable for very large and frequent file uploads compared with the post method of HTTP. However, due to special requirements stemming from the nature of e-IVSS's operation, the e-IVSS implements a subset of FTP commands, and can therefore be thought of as a higher layer application protocol “tunneled” through FTP. This means the IV˜8 uploader client is basically a simple FTP client with the ability to provide the same functionality as the file-upload section of the web-based interface and more, including multi-session file uploads. It is important to appreciate here that the uploader client is simply an uploader and is not intended to replace the entire web-based interface, but rather is only intended to improve its file uploading functionality.

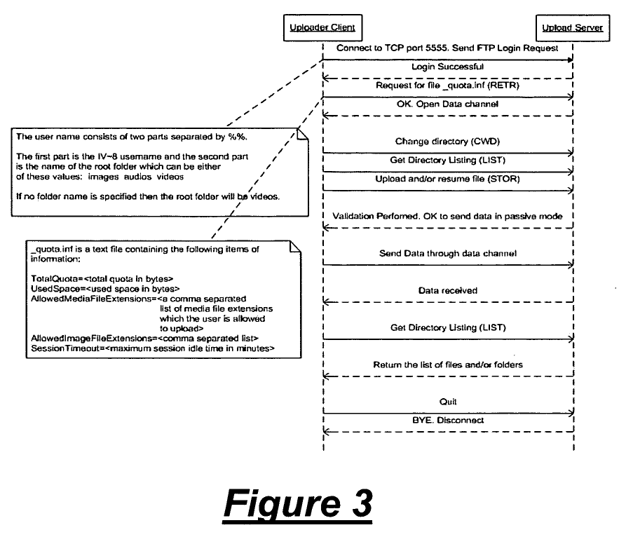

As previously mentioned, the protocol governing the communication between the uploader client and the server is tunneled through FTP. Therefore, any exchange of control information as well as file data is performed using a subset of FTP commands. The sequence diagram in FIG. 3 depicts a typical interaction between the client and server during an upload session; however, other interaction scenarios are also possible. As shown in FIG. 3, the client and the server interact like any other FTP client and server, and e-IVSS specific information is coded into FTP commands, and control information such as available quota, etc. is exchanged in the form of file downloads (retrievals). In the present description, the FTP tunneled protocol is described in terms of the messages the client can send to the server, the circumstances under which those messages are allowed to be sent, and the response the server will issue with respect to each message.

Logon Request

The client will first attempt to establish an FTP session through a TCP connection on the server port XXXX where “X” represents an internally specified controlled port number. Once the server identifies itself and demands proper credentials for authentication, the client must provide the following items of information:

1. User Name: The user name should follow a certain syntax described by the following BNF expression:

<User-Name>::=<IV8-Username>|<IV8-UserName>%%<Root-Folder>
<Root-Folder> ::= videos | audios | images

The root folder specifies what kind of file the customer wants to upload. That folder will become the root FTP folder for that session, if and after the user's credentials are successfully authenticated. If the root folder is not specified the root folder will by default be chosen by server to be the “videos” folder.

2. Password: This is the password for the user identified by e-IVSS Usemame.

Directory Listing

Once the client has successfully logged on, it can subsequently request directory listing from the server by issuing the LIST command of the FTP. This command can be issued at any time during the FTP session. The client can even accept directory names as the parameter for this command; however no additional parameters conventionally accepted by normal FTP servers are accepted. The client should NOT send such parameters. This includes but is not limited to : -I, -a, -F, or any combination of those and other UNIX like parameters. The server requires any path parameters to be in UNIX format (with forward slash as the delimiter).

Change Directory

The client can issue the CWD command of FTP as well as the CDUP command for navigating through the available directory structure. The highest level directory denoted by/is mapped to the root folder specified during logon (videos by default). CWD can be issued with a path parameter. The server will not allow any navigation to directories at any higher level than that of the root folder no matter what kind of path parameter the CWD carries with itself.

Upload File

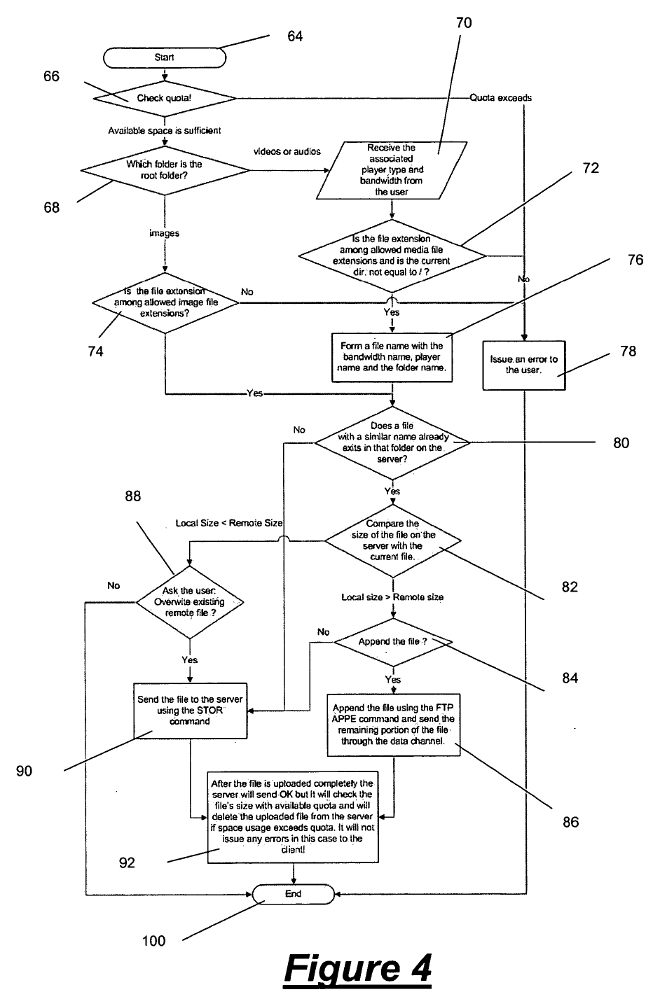

The FTP STOR and APPE commands must be issued by the client for file uploads in binary transfer mode. FIG. 4 is a flow diagram showing the steps of the procedure the client follows before sending any commands to the server. Every file that is chosen by the user to be uploaded to the server must conform to certain criteria:

1. It should have an extension that is within the list of allowed file extensions. The client can retrieve the list of allowed media file type as well as the list of allowed image file type by requesting a file from the server.

2. It should not be larger than the available disk space, which is again reflected in secured file(s).

Referring to FIG. 4, the procedure starts at 64 and a check of the quota is initially made at step 66. If the quota is exceeded, an error message is issued to the user at 78, following which the procedure ends at 100. If the quota has not been exceeded, then it has been established that sufficient space is available and a determination is made at 68 as to whether the folder is the root folder. If the folder is one containing images, the procedure proceeds to step 74 where a determination is made of whether the file extension is one among allowable image file extensions. If the file extension is not an allowable one, the procedure ends at 100, but if the extension is an allowable one, the procedure continues to step 80.

Returning to step 68, if the folder contains a video or audio file, the associated player types and bandwidth are obtained from the customer at step 70. Then, at step 72, it is determined whether the extension-of the file is among the allowable types; if it is not an allowable type, the procedure ends at 100, otherwise, the procedure continues to step 76. A file name is formed with the bandwidth name, player name and the folder name. A determination is then made at step 80 of whether a file already exists in that folder with a similar name on the server. If such a file name is not found to already exist in the folder, the procedure proceeds to step 90 where the file is caused to be sent to the server using the STOR command. If the file name is found to already exist in the folder, however, the procedure proceeds to step 82, where the size of the file on the server is compared with the current file. If the size of the local file is less than that of the remote file, the procedure continues to step 88 where the user is asked if the remote file should be overwritten. If the answer is “no”, the procedure ends at 100, otherwise the file is sent to the server using the STOR command as indicated at step 90. If the comparison made at step 82 reveals the size of the local file to be greater than that of the remote file, the process proceeds to step 84 where it is determined whether the file is appended. If the answer is “no”, the process continues to step 90, otherwise, the file is appended, at step 86, using the FTP AAPE command and the remaining portion of the file is sent though the data channel. Finally, at step 92, after the file is completely uploaded, the server will send an “OK” but it will check the file's size with available quota and will delete the uploaded file from the server if space usage exceeds quota. In the latter case, the server will not issue any error to the user.

Media (video and audio) files should adhere to additional naming standards. The file name should consist of three sections separated by underscore characters:

1. The associated bandwidth name which is currently one of the these values:
X₁, X₂, X₃ . . . Xₙ

2. The short name:
Y₁, Y₂, Y₃ . . . Yₙ. By way of example, and not limitation, players such as Windows Media Player, Real Player, QuickTime player, Flash, PocketPC Media Player, and Palm OS Kinoma Player could be respectively represented as mp, rp, qt, fl, ppcmp, plmkin. Numerous other short names may be used as additional media formats are introduced in the future.

3. The video or audio with its unique naming convention stored in a folder to which this files is being uploaded. The server will therefore reject any file uploads to the “videos” or “audios” root folders.

Thus, the file name will be in the format XXXX_YYY_MEDIANAME.EXTENSION OF VIDEO FORMAT; in which “XXXX” defines the speed of bandwidth, “YYY” is associated with the media player and the extension of video format is named by its format developer placed in a folder which is the name of the target video folder on the server. The client should ask the user for these associations and then send a file with such a format regardless of what the name of the original file submitted by the user is.

File upload resumption is supported by the ability to append to a file on a server with an identical name. The details of how the client should distinguish between a possible multi-session upload and a normal upload is indicated in the flowchart of FIG. 4.

In case of abrupt termination of a session during an upload due to any reason including but not limited to the client program being terminated by the user, getting disconnected from the network, long upload times larger than the session time out, the server will treat what it has received up to that point as a partial file with the name _INCOMPLETE_xxx_yyy_zzz.www where xxx, yyy, zzz, and www are bandwidth, player designation, folder name, and the extension of the original file. The file will therefore will not be available to the public playback until it is completed in future sessions. The client can append the remainder of the file in a later session through the mechanism explained in the flowchart.

The server will operate in both passive and active modes. However, due to the fact that e-IVSS servers are and will be almost invariably behind a firewall, the client should switch the server to passive mode so that the server announces the port number that is open for data connections.

Quota and other Status Information

File downloads are not allowed by the server. However the client can issue a RETR command for a supplied file named from the server. This file does not exist on the server and is therefore not listed by the server in any directory listing. The secured “inf” (information) file is a (clear or cipher-) text file containing lines of the form parameter−name=parameter−value each line specifying a specific status parameter of the session. The client should not assume any order for the parameters and the lines. The parameter name is case-insensitive and there is no space before or after the equals sign. By way of example, the contents of the secured “inf” file can be but is not limited to the following parameters:
TotalQuota which specifies the total disk quota allocated to the user. The value is expressed in bytes.
UsedSpace which specifies the amount of disk space in bytes that is currently in use by the user.
AllowedMediaFileExtensions which specifies a comma separated list of allowed extensions for media file for this users.
AllowedimageFileExtensions which specifies a comma separated list of allowed extensions for image files.
SessionTimeout specifies the number of minutes the server would wait before terminating a session that has been idle.

Session Timeout

In order to free up server resources for other potential users of the e-IVSS, the server will unilaterally terminate any sessions that have been idle for a certain period of time. The timeout value is adjustable on the server and in one embodiment, was set to 18 minutes. This value is specified in the “inf” files.

The details of the client-user interface for the uploader will vary depending on the application, however, there are basic facilities that will be necessary regardless of the exact type interface that is chosen. When the user issues a request for file upload by clicking on the File Upload button, the client program should activate and ask the user to re-enter his/her username and password. After logging in, the client should provide the user with the facilityto navigate through folders. When the user wants to upload a file, the client should ask the user to specify the following items of information:

1. The name and the path to the file to be uploaded.

2. The associated bandwidth of the file which is one of the following values: “XXXX where values may be LAN, 1500, 768, 512, 384, 256, 128, 64, and 56

3. The associated player software. This will be used by the player for constructing a standard name for the file to be uploaded (Refer to page 18 for details):

| Player | Value = short name |
|---|---|
| Windows Media Player | YYY = mp |
| Real Player | YYY = rp |
| QuickTime | YYY = qt |
| Flash | YYY = fl |
| PocketPC Media Player | YYY = ppcmp |
| Palm OS Kinoma Player | YYY = plmkin |
| Others | YYY = as they become available |

The client should also display to the user the percentage of the disk quota currently in use. During the upload the user should be kept informed on the upload progress by displaying the percentage of the file that is so far uploaded.

Considering the previously stated criteria and goals for the uploader, Java is may be advantageously used for implementing the uploader client. Using Java will not only provide the desired plafform-independence, but using the Java Web Start technology will also make a smooth integration into the e-IVSS web-based customer control panel possible. The Java Web start technology allows a full-fledged Java application to run inside a web-page just like an applet without the inherent security limitations of an applet such as file access. However, the Web Start enabled application, like an ActiveX component, should be digitally signed by a certificate authority to certify the uploading client's safety to the user. In the preferred embodiment of the invention, the uploader is implemented with the Java swing library to allow for a consistent look-and-feel across all platforms. Furthermore, readily available Java FTP components may be employed to expedite the development process.

The e-IVSS is preferably used in combination with certain techniques and methods which will now be described that optimize the display of video files in differing formats. Using e-IVVS, media files are categorized by their preferred media player (determined by the e-IVVS customer while uploading the file), their associated network bandwidth (also determined by the customer), their format (determined by their file extension, e.g. MPG, WMA, etc.) as well as their intended target platform (PC, PDA, etc.). For example, an MPEG file uploaded for being played whenever the user (visitor) has a LAN connection and associated with the Windows Media Player on a PocketPC platform could be called XXXX_YYYY_myfile.EXT.

At the time a visitor wants to watch/listen to a certain video/audio clip the e-IV8 auto-player then picks up the file that best fits the visitor's platform as well as her network and player configuration. There are times that only one file qualifies for being played out but usually, the number of qualified candidates are more than one. The problem is to find an algorithm that makes an optimum choice among the qualified candidates. The following will example is illustrative. Suppose that the following files are uploaded for a certain clip called MYVIDEO:
mod_mp_myvideo.wmv
lan_mp_{—}9_myvideo.wmv
lan_rp_myvideo.rm
mod_qt_{—}6-1_myvideo.mov
mod_qt_myvideo.mpg
mod_rp_myvideo.mpe
384_fl_myvideo.swf
768_rp_myvideo.rm
1500_qt_myvideo.mov
768_ppcmp_myvideo.wmv

When a user tries to play this clip using the e-IVVS's auto-player, the system will attempt to determine the platform from which the request is made based on the signature of the browser or media player. The platform will then be identified as one of the following:
1. A Pocket PC PDA running some version of the Pocket Internet Explorer Browser (this platform will be denoted ppc)
2. A Palm PDA running some version of the Palm Web Browser (platform denoted by palm)
3. A non-PDA machine

If the detected platform is determined to be a PDA, then a suitable page containing platform-compatible scripts is sent to the PDA to measure its bandwidth speed, and if it is a non-PDA platform, another page is sent to measure the connection speed as well as to determine the available movie players installed on the user's machine.

Regardless of the detected platform, the subsequent speed measurement will help e-IVVS narrow down the file choices it has for playing back to the user to those which are associated with the closest speed to the measured speed. e-IVVS will first normalize the measured speed to match it with the closest standard speed. Table 1 below lists the currently supported standard speeds. The calculated standard speed will determine the prefix of the narrowed down choices for playback. For instance, when a user with a measured speed of 34 Kbps uses the auto-player, the closest standard speed will be the 56 Kbps modem speed and therefore the choices will be narrowed down to those files that start wit mod_. It should be noted here that by “the closest” standard speed, what is meant is the closest available one. For instance, in the example of the above eight clips files, if the measured speed is 290 Kbps, then closest (available) standard speed is 384 Kbps and not 256 Kbps.

TABLE 1
Standard Bandwidths

| Standard Bandwidth Name | Description |
|---|---|
| Modem | All connections with a bandwidth lower |
| | than or equal to 56 Kbps |
| 256 | DSL connection |
| 384 | DSL connection |
| 512 | DSL/Cable Modem connection |
| 768 | DSL connection/WiFi |
| 1500 | Wi-Fi-Wi-Max |
| LAN | All connections with bandwidths |
| | starting from 10 Mbps upwards |

On non-PDA platforms, the list of installed video players along with their version numbers on the user's machine will also be detected and sent back to the e-IVVS server by a piece of client-side script. This will help e-IVVS further narrow down the list of choices for play-back even further. For instance, in the above example, the possible choices for a user with a close to modem connection speed are:
mod_mp_myvideo.wmv
mod_qt_{—}6-1_myvideo.mov
mod_qt_myvideo.mpg
mod_rp_myvideo.mpe
   Of these four, two are associated with the QuickTime player, one with RealPlayer, and one with the Windows Media Player. Assuming the user has both QuickTime and Windows Media Player installed on her machine, three out of the four above will qualify for being played and the one associated with the RealPlayer will be dropped out. For PDA's the same procedure applies except that the files will be selected based on platform as well as speed, and if applicable installed players.

The final selection of the file is performed by e-IVVS's selection algorithm which finds the appropriate file to be played by scoring each possible candidate file. The file that earns the highest score will be the one that is played. Scores comprise two components:
1. Format conformity score (a value in the range 0-10) which consists of two subcomponents itself
2. Player brand conformity score (0-7)
3. Player version conformity score (0-3)
4. Connection speed score (a value in the range 0-10)

The Player brand conformity score reflects the degree of compatibility between a file format (extension) and its customer-specified associated player. For example, a WMV file (a Microsoft proprietary format) best fits the Windows Media Player for obvious reasons. Assume that this file is associated with the RealPlayer. This reduces its format conformity score to 5.6. A WMV file associated with the Windows Media Player scores 7 in e-IVVS whereas it will score 5 if it is assigned to the RealPlayer. The less compatible the format is with the associated player, the less its player brand conformity score will be. An RM file associated with the Windows Media Player scores 0 because the Windows Media Player cannot play RM files.

TABLE 2
Player Brand Conformity Score Lookup table

| | Windows | | | |
|---|---|---|---|---|
| | Media | Real Player | QuickTime | Flash |
| ra, ram, rm | 0.0 | 7.0 | 0 | 0.0 |
| rmm, rmj | | | | |
| rmd | | | | |
| mpeg, mpg, | 7.0 | 6.3 | 3.5 | 0.0 |
| mpe, mpa | | | | |
| mp2 | | | | |
| wmv, wma, | 7.0 | 5.6 | 0.0 | 0.0 |
| asf | | | | |
| swf | 2.1 | 1.4 | 3.5 | 10.0 |
| avi, wav, | 7.0 | 5.6 | 0.0 | 0.0 |
| au, midi, | | | | |
| mid | | | | |
| rmi, m1v, | 7.0 | 0.0 | 0.0 | 0.0 |
| snd, aif | | | | |
| mov | 2.8 | 0.0 | 7.0 | 0.0 |

It should be noted here that the values shown in Table 2 above are merely illustrative, and the exact values will depend on a variety of factors, and the given application.

The connection speed score reflects how much the user's connection speed is compatible with the file's size. This score is calculated based on the assumption that the larger a file is, the higher its quality will be. The formula according to which the raw speed score is calculated is as follows:

$$RawSpeedScore = {( \frac{FileSize}{KBPS} )}^{β}$$

The file size is expressed in Kilobytes, KBPS is the connection speed expressed in Kilobytes per seconds and β is real number between −1 and 1 the bias factor. A bias factor of 1 means that the score strictly favors larger (high quality) files. A bias factor of −1 means that the score strictly favors smaller (low quality, faster downloading) files. A bias factor of 0 means that the connection speed score will not be taken into account (the system does not discriminate among files based on their size). The bias factor is determined individually for each clip folder by the customer. This is indicated in the e-IVSS user interface as a sliding track bar labeled “Auto-play Performance”. When the track is slid towards the side indicated as “Best Quality”, the bias factor is moved closer to 1 and when it is slid towards “Better Speed” the bias factor is moved closer to −1. When the track is in the middle, the bias factor is zero. The raw speed scores are then normalized into values in the range 0-10 by dividing them all by the highest speed score among the list of candidates. Therefore, the speed score is a relative score and a file may be scored differently when appearing in different candidate lists.

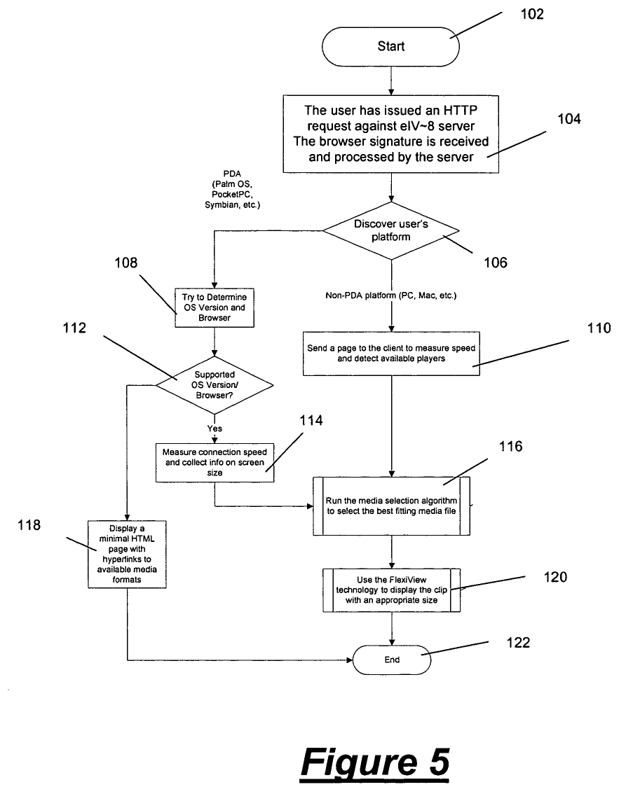

The flowcharts shown in FIGS. 5-7 will down be described which illustrate the method by which a media file selected by e-IVVS's auto-selection mechanism for playing.

FIG. 5 a flow chart showing the broad steps comprising the method by which a media file is selected by the e-IVSS for playing on a user's computer. Beginning at the start 102, the user issues an HTTP request against the e-IVSS server, following which the browser signature is received and processed by the IVSS as shown at step 104. Then, at step 106, a decision is made regarding the type of platform being used by the user. If the platform is a non-PDA platform, i.e. PC, Mac, etc, then the process proceeds to step 110 where the IVSS sends a page to the user in order to measure the speed and detect the players that are available on the users computer. Having detected the connection speed and the players available at the user's site, the process proceeds to step 116 in which the media selection algorithm is run in order to select the best fitting media file. Returning to step 106, in the event that the detected platform is a PDA, then the process proceeds to step 16 where an attempt is made to determine the type of OS (operating system) version and browser. At step 112, if the OS version/browser is one that is supported, then the process continues to step 114 where the connection speed is measured and information is collected regarding the users screen size. Following step 114, the process proceeds to step 116 where the media selection algorithm selects the best fitting media file. If, however, the OS version/browser is not one that is supported, then, at step 118, a minimal HTML page is displayed with hyperlinks to available media formats. If the operating system version/browser is supported, then following the selection of the best fitting media file at step 116, a procedure is carried out at step 120 which displays the video clip at a size that best fits the users screen. The process ends at step 122.

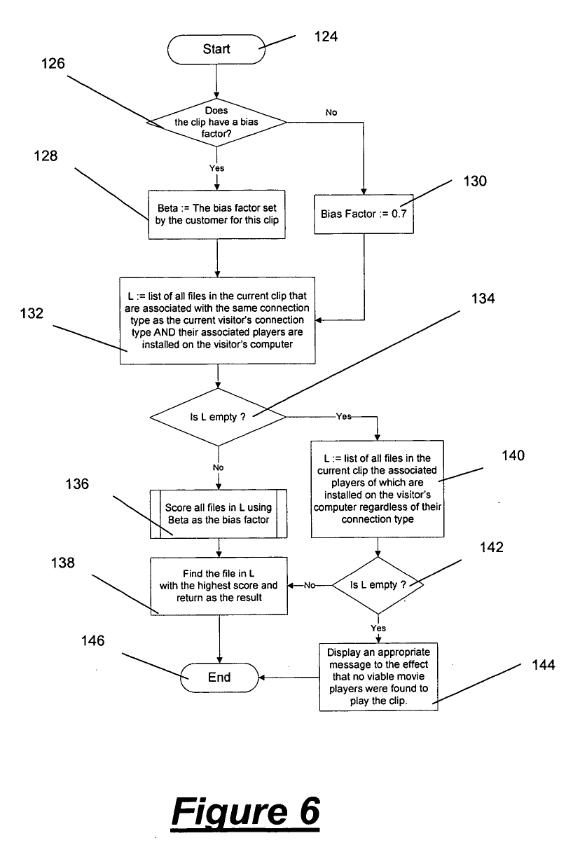

The media selection technique described above comprises a series of method steps which will now be further described in outline form with reference to the flow chart shown in FIG. 6. The selection process starts at step 124, following which a determination made of whether the video clip has a bias factor at 126. If the clip does not have a bias factor, then the bias factor is set equal to a predetermined value, herein chosen to be 0.7, as is shown at step 130. On the other hand, if the video clip does have a bias factor, it is set by the customer at step 128. The bias factor having been set, a list L is made at step 132 comprising all files in the current video clip that are associated with the same connection type as the current user's connection type and their associated players are installed on the user's computer. With the video clips and the associated players having been installed on the user's computer at step 132, a determination is made at step 134 as to whether the list L is empty. If the list is not empty, then all files and the list L are scored using beta as the bias factor, as shown at step 136. Then, at step 138, the file in the list L is selected having the highest score and this file is returned as a result at step 138. On the other hand, if the list L is empty then, L is set equal to the list of all files of the current video clip, the associated players of which are installed on the users computer regardless of their connection type, as shown in step 140. Then, a further determination is made of whether the list L is empty, at step 142. If the list L is not empty, the process progresses to step 138, however if the list is empty, the process proceeds to step 144 which consists of displaying an appropriate message to the effect that no viable movie players were found to play the video clip. Following the completion of either steps 138 or 144, the process ends at 146.

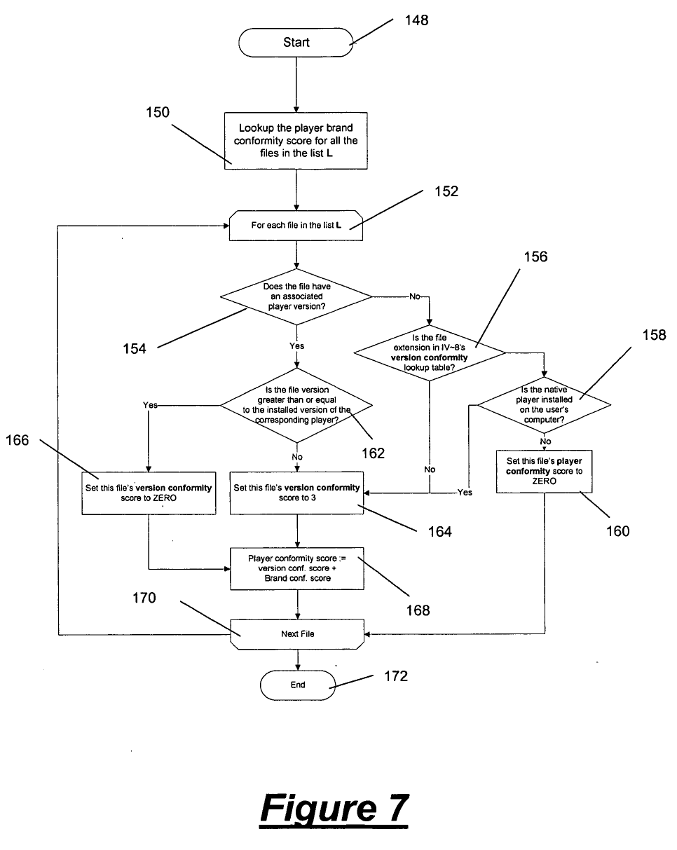

The player conformity scoring method described above will now be described in outline form with reference to the flow chart shown in FIG. 7. The scoring procedure starts at 148, following which a lookup is made of the player brand conformity score for all files listed in the list L as shown in step 150. Then, a series of steps are performed for each file in the list L as shown in step 152. First, a determination is made at step 154 as to which the file has an associated player version. If the file does have an associated player version, the process proceeds to step 162, otherwise the process proceeds to step 156 where a determination is made of whether the file extension is present in the IVSS version conformity lookup table. If the file extension is found in this lookup table, the process proceeds to step 158 where a determination is made as to whether the native player is installed on the user's computer. If the player is not installed in the user's computer, the process proceeds to step 160 where the files player conformity score is set to zero, following which the process proceeds to step 170. On the other hand, if the native player is found to be installed on the user's computer, the process proceeds to step 164.

At step 162, a determination is made as to whether the final version is greater than or equal to the installed version of the corresponding player. If the answer to the question posed at step 162 is “yes”, the process proceeds to step 166 wherein the file version conformity score is set to zero. If the answer to the question posed at step 162 is “no”, then the file version conformity score is set to 3, as noted at step 164. Following the setting of the conformity scores in steps 164 and 166, the player conformity score is determined based on the sum of the version conformity score plus the brand conformity score, as shown at step 168. With this scoring complete, the process is repeated for each file at step 170, until all the files have been processed, following which the procedure ends at step 172.

e-IVSS maintains different versions of the same video production with different play-back qualities. Using the methodology and techniques described below, e-IVSS selects the candidate that best fits the configuration of the user's computer and network connectivity. However, due to the varying pixel resolution of these versions, it is sometimes desirable to play back each file with a specific and carefully selected width and height to give the user the best viewing experience possible. e-IVSS performs this width/height adjustment based on the configuration of the user's computer as well as the preferred size associated with each bandwidth. At the time a visitor wants to watch a certain video clip the e-IVSS auto-player should be able to resize itself to playback the best fitting media clip in its most appropriate form.

In e-IVSS, every standard bandwidth can be associated with a video size. For instance, if the “modem” bandwidth is associated with 240×180 then it means that a clip selected by IV˜8 to be played back to a user with a detected modem connection, will be displayed in a player frame size of 240×180 pixels. This association can be introduced to IV˜8 at either the global level or the folder level. The global level is determined and adjustable by the e-IVSS administrator. The folder level is defined individually for each video folder by the customer that creates that folder.

The customer has also the choice of fixing the size of the clips played back irrespective of the detected bandwidth. This virtually causes the automatic adjustment mechanism described above to be bypassed. The fixed player size can also be specified both at the global as well as the folder level. Table 3 below shows a sample size-bandwidth designation.

TABLE 3-3
A sample size-bandwidth designation (values are set by the content
provider)

| Standard Bandwidth | Designated Player |
|---|---|
| Name | Size (width × height) |
| Modem | 240 × 180 |
| 256 | 320 × 240 |
| 384 | 320 × 240 |
| 512 | 320 × 240 |
| 768 | 320 × 240 |
| 1500 | 800 × 640 |
| LAN | 800 × 640 |

Under certain circumstances, e-IVSS automatically bypasses the user- or admin-defined designations and adjusts the size of the player to an appropriate width and height. This applies but is not limited to the following situations:
1. On PDA devices that specifically announce their display size in their browser identification string (a.k.a. browser signature). IV˜8 will snap the clip to the available screen width and height in case the designated size is larger than the size of the PDA's LCD.
2. On a non-PDA client, if the user has set the screen resolution to a size less than the designated size in IV˜8, then the player will be adjusted to fit the user screen size.

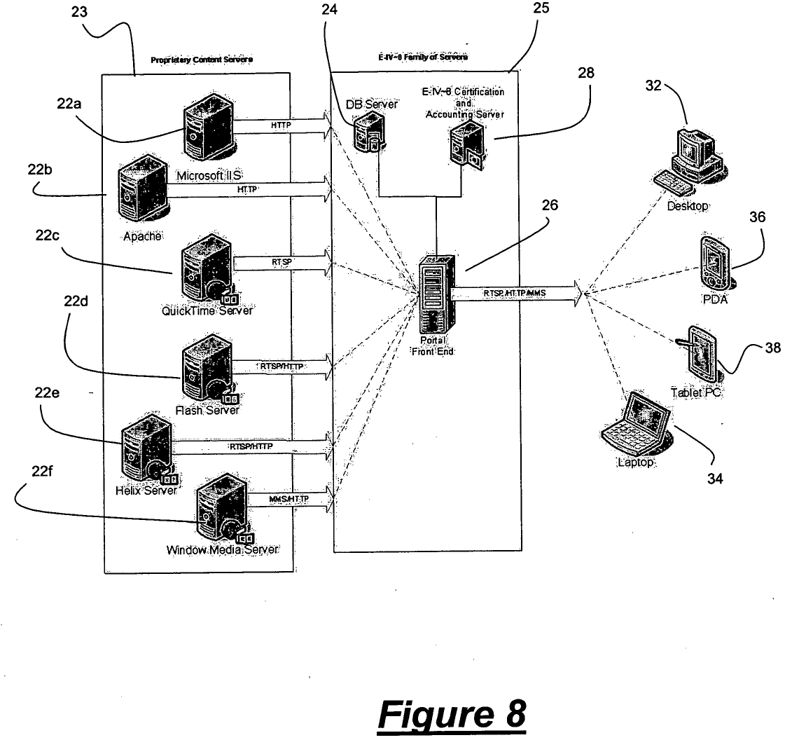

It is to be understood that the specific methods and techniques which have been described are merely illustrative of one application of the principle of the invention. Numerous modifications may be made to the method as described without departing from the true spirit and scope of the invention. By way of illustration, referring to FIG. 8, the e-IVSS family of servers 25 can be used as a gateway or conduit between a group 23 of servers 22a-22f storing multimedia files in proprietary formats, and a plurality of user sites (devices 32-38). The servers 22a-22f may be RTSP (real time streaming protocol) servers and/or MMS (multimedia messaging service) servers, for example. Acting virtually as a firewall between the servers 22 and the user sites, the e-IVSS server family 25 functions to intelligently channel video streaming in the RTSP or MMS protocols from the servers 22a-22f to the users 32-38.

1. A method of sending and playing video files using TCP/IP or the Internet, comprising the steps of:
(A) storing the files at a file server site;
(B) sending a video file request from a user site to an intelligent streaming server at the file server site;
(C) receiving the video file request at the file server site;
(D) determining the optimum settings of video for the requested video file using an intelligent scoring algorithm;
(E) in response to the video file request, streaming the contents of the requested video file to the user using TCP/IP or Internet; and, (F) playing the requested video file being streamed at the user site using the optimum settings determined in step (D).

2. The method of claim 1, wherein:
the files are stored in a plurality of storage servers at the server site,
the video file request is received at the server site by a portal server, and
the portal server selects the server in which the requested video file is stored.

3. The method of claim 2, including the steps of:
transmitting security information along with the video file request from the user site which uniquely identifies the user,
using the portal server to authenticate the user using the transmitted security information, and
directing the video file request to the selected server.

4. The method of claim 2, including the step of maintaining accounting information on the intelligent streaming server relating to the user's video file requests and the user's credit.

5. The method of claim 2, including the step of establishing communications between the intelligent streaming server and third party e-commerce service providers.

6. The method of claim 1, wherein step (B) is performed using a web browser.

7. The method of claim 1, wherein step (D) is performed by the intelligent streaming server.

8. The method of claim 1, wherein step (F) is performed using one of a PDA, PC, laptop, web-enabled cellular telephone, mobile phone, or wireless appliance.

9. The method of claim 1, wherein step (D) includes:
selecting one from at least two video files representing the same video production corresponding to the video file request but having differing video play-back qualities;
generating a video image by playing back the selected video file; and,
adjusting at least one of the height and width of the generated video image.

10. The method of claim 1, wherein step (F) is performed using one of the following players: Microsoft Windows Media Player, RealNetworks RealOne, Apple QuickTime or Macromedia Flash Player.

11. The method of claim 1, wherein step (E) includes uploading the requested video file using FTP.

12. The method of claim 1, wherein step (D) includes:
selecting one from at least two video files representing the same video production but having differing video play-back qualities, wherein the selection is based on at least one of the following:
the type of video player available to the user for play-back of the requested video file,
the bandwidth available for transmission of the requested video file to the user,
the format of each of the requested video file, and
the type of platform available to the user for play-back of video files.

13. The method of claim 12, wherein step (F) includes:
generating a video image by playing back the selected video file, and,
adjusting at least one of the height and width of the selected video image.

14. A method for sending and playing media files on demand, comprising the steps of:
(A) hosting a plurality of media files at a server site;
(B) receiving requests for media-on-demand from users, wherein each request represents a demand by a user that a user-selected media file be uploaded from the server site for playing at the user's site;
(C) uploading the requested media files to the users' sites using an intelligent streaming server to stream the media files using FTP/IP or the Internet;
(D) optimizing the display of the uploaded files at the users' sites using an intelligent scoring algorithm; and,
(E) playing the requested media files at the users' sites in a form optimized in step (D).

15. The method of claim 14, wherein step (A) includes storing the media files on a plurality of host servers, and using a portal server to select the host server from which each of the media files is to be uploaded.

16. The method of claim 14, wherein step (D) is performed by the intelligent streaming server.

17. The method of claim 14, wherein step (E) is performed using one of a PDA, PC, web-enabled cellular telephone, or laptop computer.

18. The method of claim 14, wherein step (D) includes:
selecting one from at least two media files representing the same media production corresponding to the media file request but having differing media play-back qualities;
generating a video image by playing back the selected media file; and,
adjusting at least one of the height and width of the generated video image.

19. The method of claim 14, wherein step (E) is performed using one of the following players: Microsoft Windows Media Player, RealNetworks RealOne, MPEG, Apple QuickTime or Macromedia Flash Player.

20. The method of claim 14, wherein step (C) includes uploading the requested video file using FTP.

21. The method of claim 14, wherein step (D) includes:
selecting one from at least media files representing the same media production but having differing video play-back qualities, wherein the selection is based on at least one of the following:
the type of media player available to the user for play-back of the requested media file,
the bandwidth available for transmission of the requested media file to the user,
the format of each of the requested media file, and
the type of platform available to the user for play-back of media files.

22. The method of claim 14, wherein step (E) includes:
generating a video image by playing back the selected media file, and,
adjusting at least one of the height and width of the video image.

23. A method of uploading a video file from a computer to a user site through a TCP/IP network or the internet connection, comprising the steps of:
(A) sending a file upload request from the user site to the computer;
(B) sending information from the user site to the computer identifying the name and path of the video file to be uploaded, the speed of the user's connection and the type of player that the user will use to play the uploaded video file;
(C) selecting a video file that best matches he information provided by the user; and, (D) uploading the file selected in step (C).

24. The method of claim 23, including forming a name for the requested video file, wherein the file name includes identification of the bandwidth associated with the file, the name of the player and the name of the video folder to which the file is to be uploaded.

25. The method of claim 23, including the step of determining at the computer if the file extension of the file requested to be uploaded is a permitted extension supported by the computer.

26. The method of claim 23, including the step of displaying to the user the amount of disk quota in the computer being used by the user.

27. The method of claim 23, wherein steps (A) and (B) are performed using a subset of FTP.

28. A system for sending and playing media files on demand using TCP/IP or the Internet, comprising:
at least one server computer for hosting a plurality of media files that may be uploaded to users on-demand for playing;
an uploader responsive to demands for files from users, for uploading media files from the server to the users; and,
a set of programmed instructions for selecting media files that optimize file playback based on the user's preferred media player, the file format and the bandwidth of the connection between the user and the server.

29. A system for sending and playing media files on demand using TCP/IP or the Internet, comprising:
a plurality of server computers each hosting a plurality of media files that may be uploaded to users on-demand;
an uploader responsive to demands for files from users, for uploading media files from the server to the users;
a set of programmed instructions for selecting media files that optimize file playback based on the user's preferred media player, the file format and the bandwidth of the connection between the user and the server; and,
an accounting module for handling payment transactions involving the users;
a front end portal server responsive to a demand for a file upload from a user to redirecting the user to the server hosting the media file that the user has demanded for upload

30. The system of claim 29, including a certification module forming a gateway between the front end portal and the accounting module, ands operable to verify that the user has sufficient credit to allow a file upload.

31. The system of claim 29, wherein the front end server is operable to receive credentials from the users and communicates with the accounting module to verify that a user is permitted to upload a demanded media file.
